(19) United States
(12) Patent Application Publication
(10) Pub. No.: US 2011/0247261 A1
(43) Pub. Date: Oct. 13, 2011

(54) FISHING JIG

(76) Inventor: Fred Mason, San Clemente, CA (US)

(21) Appl. No.: 12/756,946

(22) Filed: Apr. 8, 2010

(51) Int. Cl. A01K 91/04

(52) U.S. Cl. 43/44.92

(57) ABSTRACT

A wahoo fishing jig comprises a barrel swivel, a first ring welded to the barrel swivel, a chain body having a plurality of links connected with the first ring, a second ring connected to a last link of the plurality of links, J hook connected to the second ring, a hook flag hanging from the J hook, and a pair of hard rubber black washers connected by a barrel and held by a pair of screws that freely moves inside a first link of the plurality of links. The chain body and the pair of hard rubber black washers produce noise in water and the pair of hard rubber black washers secured by the pair of screws resembles floating eyes. The chain body collapses and the J hook swings into the mouth and face of the wahoo fish regardless of on which link the wahoo fish bites.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to a fishing jig, and more particularly to a fishing jig made for wahoo fishing.

### DISCUSSION OF RELATED ART

Many jigs have been designed to imitate a small fish and to move erratically through the water when the jig is trolled or jigged. Jigs and lures with skirts have been used to produce this irregular movement. U.S. Pat. No. 5,899,015 entitled “fishing jig with recessed skirt” issued to Link discloses a jig or sinker head having a recessed portion for accommodating a hook eye within. Similarly jigs having a lead head with a plastic skirt are described in U.S. Pat. No. 4,920,688 entitled “swivel jig fishing lure” issued to Devereaux and U.S. Pat. No. 5,175,955 entitled “fishing lure” issued to Wilson. Jigs and lures exemplified by the aforementioned patents have several disadvantages. Such arrangements have been designed solely for use in shallow water, and are generally unsuited for deep-water fishing.

Alternatives have been developed to improve these conventional jig-type lures. One example is disclosed in U.S. Pat. No. 6,708,442 entitled “hood for artificial lure and baitfish” issued to Kress. The Kress patent teaches a soft, flexible plastic fishing lure body portion having a cavity into which a removable weight is inserted so that the lure will have a swimming or crank-bait type of action when it is reeled in. Fishing lures having an internal rattle mechanism for attracting fish have been taught in U.S. Pat. No. 4,791,750 entitled “fishing lure with internal rattle” issued to Gammill and U.S. Pat. No. 5,001,856 entitled “rattling fishing lure” issued to Gentry. The shortcoming of these is inventions is that the noise emitted is not loud enough for the target fish to hear or pick up with a lateral line. Moreover, the hook has the tendency to slide away prematurely from the fishing line, resulting in the appearance of a bare hook that is not likely to attract the fish. Further, construction of the lures described in the above patents is not suited for large fish such as wahoo that have long, toothy jaws.

U.S. Pat. Application No. 20080060254 entitled “Self Baiting Fishing Rig and Method of Fishing” to Bloomfield provides a fishing rig having a leader with a first and second end, at least one bait hook attached to the leader, and at least one game fish hook attached to the leader. Such a rig is very complex in design, complicating and increasing the cost of manufacture. Further, when the line is jigged, or raised up and down, this device will generally sink with the hook upwardly disposed and will therefore tend to grapple and tangle the fishing line.

Therefore, there is a need for a simple fishing jig made for large fish, such as wahoo, tuna, kingfish, Dorado, and other large game fish, suitable for deep-water fishing, and can undergo a variety of erratic movements without tangling the fishing line when it is trolled or jigged. Further, such a device would create a substantial amount of noise in the water attracting the target fish. Such a needed device would be rugged, durable, and economical. The present invention accomplishes these objectives.

### SUMMARY OF THE INVENTION

The present invention is a wahoo fishing jig having a chain body design. The wahoo fishing jig comprises a barrel swivel, a first ring welded to the barrel swivel, a chain body having a plurality of links connected with the first ring, a second ring connected to a last link of the plurality of links, and a J hook connected to the second ring. Further the wahoo fishing jig comprises a pair of hard rubber black washers connected by a barrel and held by a pair of screws. The pair of hard rubber black washers is capable of freely moving inside a first link of the plurality of links with each hard rubber black washer being on each side of the first link. When a wahoo fish strikes the chain body, the chain body collapses and the J hook swings into the mouth and face of the wahoo fish regardless of on which link the wahoo fish bites.

The pair of screws provides an appearance of eye pupil when drawn through the water. Thus the pair of hard rubber black washers secured by the pair of screws resembles floating eyes that are free floating and moving. The pair of hard rubber black washers is designed to slip and move within the first link of the plurality of links.

The element of noise is significant in attracting fish, as many of the larger fish pick up noise via their lateral line which is a sense organ that consists of a row of scales that most fish have along their sides, extending from their head to tail. Under these scales are a systems of fluid-filled canals and specialized cells which transmit vibrations to the brain of the fish. The lateral line helps fish to detect movement and vibration in the surrounding water including predators and prey. The chain body by design makes a substantial amount of noise in the water attracting wahoo fish.

Also the pair of hard rubber black washers secured by the pair of screws that gives the appearance of floating eyes, makes a great deal of noise because the barrel taps against the chain body repeatedly attracting the wahoo fish by sound.

The barrel swivel prevents the chain body from twisting. The first ring may be made larger than the second ring as the wahoo fish has more of a chance to slip into a hook with a small ring at the bottom. The wahoo fishing jig may include a hook flag hanging from the J hook that can be made of a variety of different colors to entice the wahoo fish into biting the jig. In use, the wahoo fishing jig can be cast into the water with a fishing rod and a reel and the jig should be allowed to sink about 100 feet. When the wahoo fishing jig hits the water and is retrieved, the wahoo fishing jig squirms and swims by the weight of the J hook and due to the combination of all the parts.

### DESCRIPTION OF THE DRAWINGS

FIG. 1 is a side perspective view of a wahoo fishing jig of the present invention;

FIG. 2 is a side view of the wahoo fishing jig in accordance with the present invention; and

FIG. 3 is a front view of the wahoo fishing jig of the present invention.

### DETAILED DESCRIPTION OF THE PREFERRED EMBODIMENT

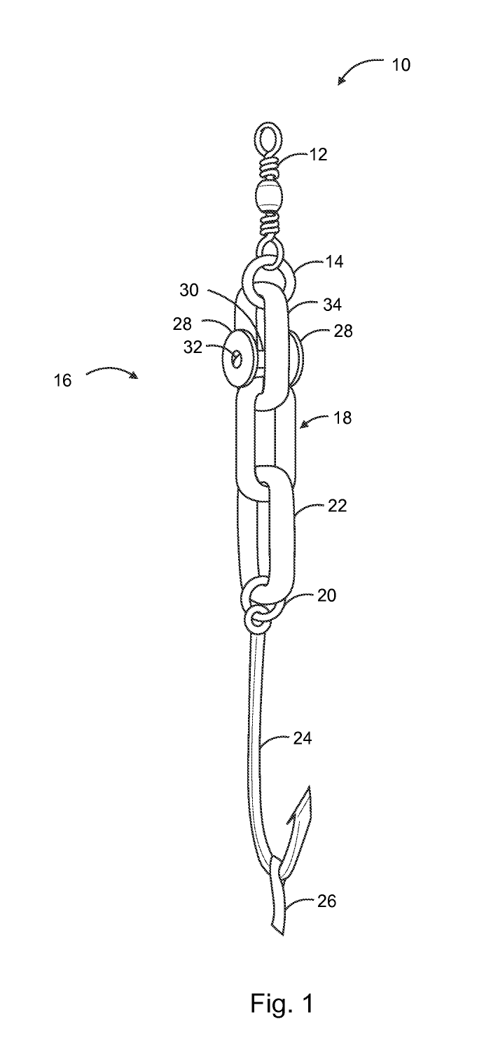

FIG. 1 shows a side perspective view of a wahoo fishing jig 10 according to the present invention. The wahoo fishing jig 10 comprises a barrel swivel 12, a first ring 14 welded to the barrel swivel 12, a chain body 16 having a plurality of links 18 connected with the first ring 14, a second ring 20 connected to a last link 22 of the plurality of links 18, a J hook 24 connected to the second ring 20, and a hook flag 26 hanging from the J hook 24. The wahoo fishing jig 10 further comprises a pair of hard rubber black washers 28 connected by a barrel 30 and held by a pair of screws 32. The pair of hard rubber black washers 28 is capable of freely moving inside a first link 34 of the plurality of links 18 with each hard rubber black washer 28 being on each side of the first link 36. When a wahoo fish strikes the chain body 16, the chain body 16 collapses and the J hook 24 swings into the mouth and face of the wahoo fish regardless of on which link the wahoo fish bites.

The pair of screws 32 provides an appearance of eye pupil when drawn through the water. Thus the pair of hard rubber black washers 28 secured by the pair of screws 32 resembles floating eyes that are free floating and moving. The pair of hard rubber black washers 28 is designed to slip and move within the first link 34.

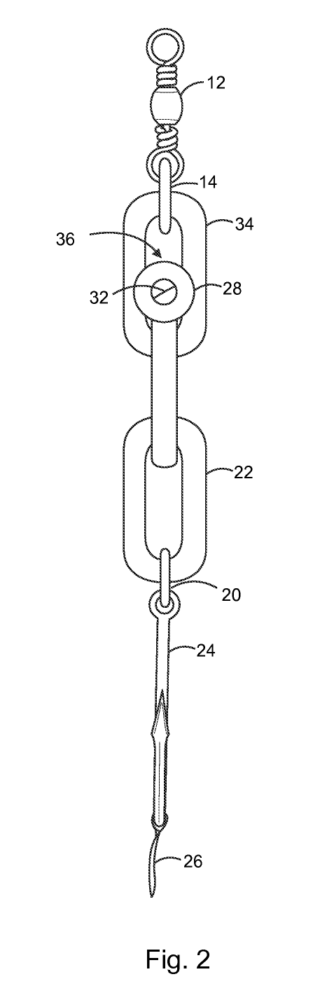

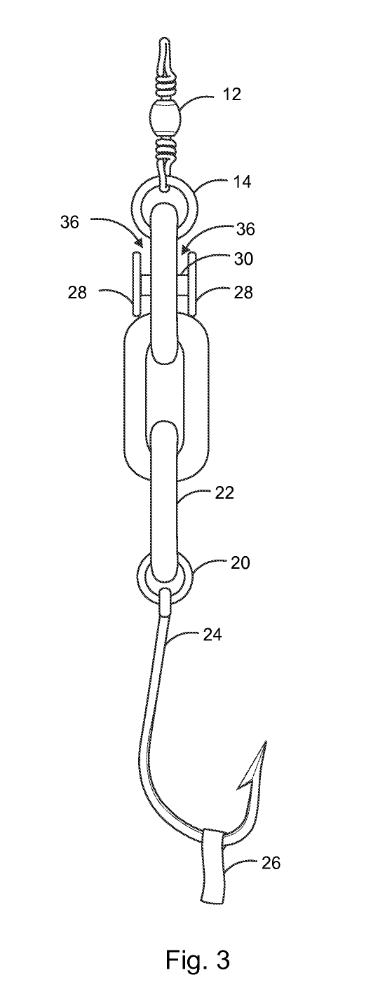

It is a known fact that the wahoo fishes gets attracted to sound easily. As shown in FIGS. 2 and 3, the chain body 16 by design makes a substantial amount of noise in the water attracting the wahoo fish. Also the pair of hard rubber black washers 28 secured by the pair of screws 32 that gives the appearance of floating eyes, makes a great deal of noise because the barrel 30 taps against the chain body 16 repeatedly attracting the wahoo fish by sound.

The barrel swivel 12 prevents the chain body 16 from twisting. The first ring 14 may be made larger than the second ring 20 as the wahoo fish has more of a chance to slip into a hook with a small ring at the bottom. The hook flag 26 may be made of a variety of different colors to entice the wahoo fish into biting the wahoo fishing jig 10. In use, the wahoo fishing jig 10 can be cast into the water with a fishing rod and a reel and the wahoo fishing jig 10 should be allowed to sink about 100 feet. When the wahoo fishing jig 10 hits the water, the wahoo fishing jig 10 squirms and swims by the weight of the J hook 24 and due to the combination of all the parts.

The barrel 30 can be made of aluminum and the first ring 14 and second ring 20 can be made of solid stainless steel. The swing arm effect of the wahoo fishing jig 10 causes more solid hook ups and the wahoo fish can be caught much easier by novice as well as expert anglers even though the wahoo fish is extremely hard to hook because of the structure and hardness of the mouth.

While a particular form of the invention has been illustrated and described, it will be apparent that various modifications can be made without departing from the spirit and scope of the invention. Accordingly, it is not intended that the invention be limited, except as by the appended claims.

What is claimed is:

1. A fishing jig, comprising:
a barrel swivel;
a first ring welded to the barrel swivel;
a chain body having a plurality of links connected with the first ring;
a second ring connected to a last link of the plurality of links;
a J hook connected to the second ring;
a hook flag hanging from the J hook; and
a pair of hard rubber black washers connected by a barrel and held by a pair of screws, the pair of hard rubber black washers being capable of freely moving inside a first link of the plurality of links with each hard rubber black washer being on each side is of the first link.
whereby the chain body collapses and the J hook swings into the mouth and face of a wahoo fish regardless of on which link fish bites.

2. The fishing jig of claim 1 wherein the chain body and the pair of hard rubber black washers produce a substantial amount of noise in water to attract fish.

3. The fishing jig of claim 1 wherein the pair of screws used to secure the pair of hard rubber black washers when drawn through the water provides an appearance of eye pupil.

4. The fishing jig of claim 1 wherein the wahoo fishing jig can be cast into the water with a fishing rod and a reel.

5. The fishing jig of claim 1 wherein the barrel swivel may prevent the chain body from twisting.

6. The fishing jig of claim 1 wherein the first ring may be larger than the second ring.

7. The fishing jig of claim 1 wherein the hook flag may be made of a variety of different colors to entice fish into biting the jig.
